(19) United States
(12) Patent Application Publication
(10) Pub. No.: US 2013/0007354 A1
(43) Pub. Date: Jan. 3, 2013

(54) DATA RECORDING DEVICE AND DATA RECORDING METHOD

(76) Inventor: Hidetaka SHIIBA, Osaka (JP)

(21) Appl. No.: 13/608,328

(22) Filed: Sep. 10, 2012

Related U.S. Application Data
(63) Continuation of application No. PCT/JP2011/000400, filed on Jan. 26, 2011.

(30) Foreign Application Priority Data
Mar. 29, 2010 (JP) 2010-075897

(51) Int. Cl. G06F 12/02

(52) U.S. Cl. 711/103; 711/E12.008

(57) ABSTRACT

A data recording device according to the present invention includes a virtual device control unit that controls, as a single virtual device, at least a part of a memory area of the first flash memory recording medium and at least a part of a memory area of the second flash memory recording medium; and a file management unit that performs a programming process and an erasing process in parallel, the programming process for programming data in a memory area included in the virtual device and the first flash memory recording medium, and the erasing process for erasing data from a memory area included in the virtual device and the second flash memory recording medium.

### CROSS REFERENCE TO RELATED APPLICATIONS

This is a continuation application of PCT Patent Application No. PCT/JP2011/000400 filed on Jan. 26, 2011, designating the United States of America, which is based on and claims priority of Japanese Patent Application No. 2010-075897 filed on Mar. 29, 2010. The entire disclosures of the above-identified applications, including the specifications, drawings and claims are incorporated herein by reference in their entirety.

### FIELD

The present invention relates to a data recording method for performing high-speed data recording on a data recording device including flash memory recording media.

### BACKGROUND

For digital audiovisual equipment for recording content such as digitalized video and audio, there has been an increasing number of digital audiovisual equipment in recent years that includes flash memory recording media for storage purposes. For instance, such audiovisual equipment includes digital movie equipment including SD memory cards or embedded SD cards as storage devices.

This is because the flash memory recording media have conventional excellent advantages such as small size and small weight, electric power saving, and high strength for impact. Moreover, the flash memory recording media have been increasing in capacity and becoming cheaper in recent years. Thus, the flash memory recording media are becoming common as an alternative for hard disks.

It seems that a stable recording speed that is a high and constant speed will be required for the flash memory recording media as a large capacity storage as same as other large capacity storages. For instance, the stable recording speed that is a high and constant speed is required for recording media when recording, for example, high-definition moving images in movie equipment, multichannel stream in recording equipment, and continuously shot images in a digital still camera.

However, widely used conventional flash memory recording media have problems for the above requirement.

Recording on many flash memory recording media at a high and constant recording speed is possible only when recording is performed on a data-erased area (free area) of over a certain size. In other words, when a memory area storing unerased data of a flash memory recording medium is overwritten, a recording speed decreases to some extent. This is because when the memory area storing unerased data is overwritten, an erasing process and a data transferring process are performed on a flash memory chip embedded in the flash memory recording medium in addition to performing a programming process on the flash memory chip. This decreases a speed of the whole recording process. As an example of the above, a class 10 SD memory card guarantees a write rate of 10 MB/sec or more but only for a certain area where data is erased.

A method recited in. Patent Literature 1 is a method for speeding up a recording speed of a system that includes flash memory recording media having the above characteristics. The method recited in Patent Literature 1 performs a parallel programming process or a simultaneous erasing process on the flash memory recording media This allows the method in Patent Literature 1 to speed up a recording speed.

Citation List

Patent Literature

[PTL 1] Japanese Unexamined Patent Application Publication No. 10-69420

### SUMMARY

### Technical Problem

As mentioned above, a recording device using flash memory recording media as storage has a problem for a recording speed when overwriting. A method for performing format processing before programming to erase data of an entire area is a method to solve the above problem. However, since the format processing including the erasing process needs a long period of time for processing, another problem appears that programming can not be started at any time, for example, when programming is started immediately after the start of audiovisual equipment.

Moreover, the method recited in Patent Literature 1 for dividing data and performing the programming process and the erasing process, in parallel, on flash memory recording media have a shorter period of time for a whole recording process. However, when enough data-erased area is not available in the recording medium, it is necessary to temporarily stop the programming process and perform the erasing process. Alternatively, it may be possible to leave the processing to the internal processing of the flash memory recording medium without performing the erasing process. However, in this case, it is difficult to guarantee the minimum recording speed, thus causing a difficulty assuring a constant recording speed. As mentioned above, a problem remains more or less unresolved when continuously recording high-definition moving images during which the method of Patent Literature 1 requires a recording speed that guarantees a constant speed or the minimum speed.

In view of the above problems, an object of the present invention is to provide a data recording device that uses flash memory recording media as storage and can achieve recording at a high and constant recording speed.

### Solution to Problem

To achieve the above problems, a data recording device according to an embodiment of the present invention for recording data on a first flash memory recording medium and a second flash memory recording medium, the data recording device including: a virtual device control unit that controls, as a single virtual device, at least a part of a memory area of the first flash memory recording medium and at least a part of a memory area of the second flash memory recording medium; and a file management unit that performs a programming process and an erasing process in parallel, the programming process for programming data in a memory area included in the virtual device and the first flash memory recording medium, and the erasing process for erasing data from a memory area included in the virtual device and the second flash memory recording medium to generate a free area to be a programming destination in a subsequent programming process.

### Advantageous Effects

The present invention can provide a data recording device that uses flash memory recording media as storage and can achieve recording at a high and constant recording speed.

### BRIEF DESCRIPTION OF DRAWINGS

These and other objects, advantages and features of the invention will become apparent from the following description thereof taken in conjunction with the accompanying drawings that illustrate a specific embodiment of the present invention.

FIG. 1 illustrates the whole configuration of a data recording device according to the first embodiment of the present invention.

FIG. 2 illustrates the inner structure of a data recording device according to the first embodiment of the present invention.

FIG. 3 illustrates a procedure example of a data recording method according to the first embodiment of the present invention.

FIG. 4 illustrates an example of an address map table according to the first embodiment of the present invention.

FIG. 5A illustrates an image of programming process for a recording medium in a data recording method according to the first embodiment of the present invention.

FIG. 56 illustrates an image of erasing process for a recording medium in a data recording method according to the first embodiment of the present invention.

FIG. 6 is a timing chart of a data recording method according to the first embodiment of the present invention.

FIG. 7 illustrates an example of a creation procedure of virtual device file management information according to the first embodiment of the present invention.

FIG. 8 illustrates the inner structure of a data recording device according to the second embodiment of the present invention.

FIG. 9 illustrates a procedure example of data aggregating process according to the second embodiment of the present invention.

FIG. 10 illustrates assignment of logical addresses according to the third embodiment of the present invention.

FIG. 11 illustrates a procedure example of data aggregating process according to the third embodiment of the present invention.

FIG. 12 illustrates an example of a procedure for switching memory cards according to the fourth embodiment of the present invention and continuing to record.

### DESCRIPTION OF EMBODIMENTS

Embodiments of data recording devices according to the present invention will be described in detail with reference to the drawings.

### Embodiment 1

A data recording device according to the first embodiment of the present invention performs, in parallel, a process of programming data in a first flash memory recording medium included in a virtual device and a process of erasing data from a second flash memory recording medium included in the virtual device. This allows the data recording device according to the first embodiment of the present invention to record at a high and constant speed.

The configuration of the data recording device according to the first embodiment of the present invention will be described.

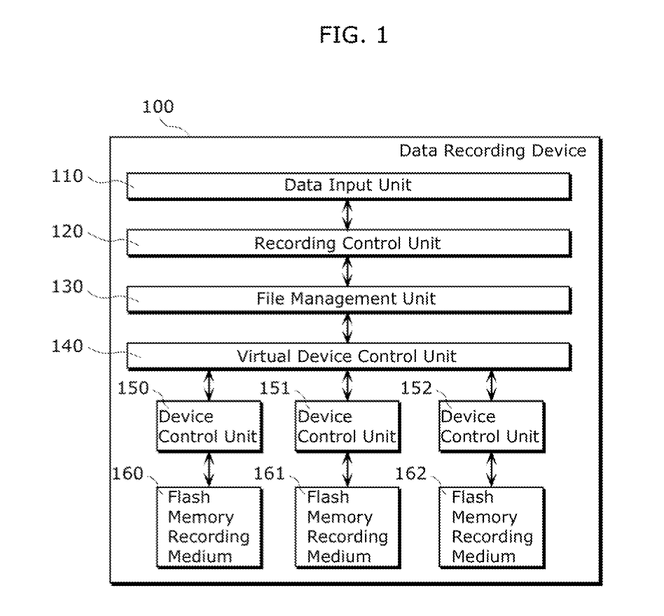

FIG. 1 illustrates a basic configuration of a data recording device 100 according to the first embodiment of the present invention. The data recording device 100 shown in FIG. 1 includes a data input unit 110, a recording control unit 120, a file management unit 130, a virtual device control unit 140, device control units 150, 151, and 152, and flash memory recording media 160, 161, and 162. This data recording device 100 records data on the flash memory recording media 160, 161, and 162. Moreover, the flash memory recording media 160, 161, and 162 may be embedded in the data recording device 100 or may be removable from the data recording device 100.

The data input unit 110 obtains content data such as video or sound input from an external device and an instruction to write the content data.

The recording control unit 120 stores the content data obtained by the data input unit 110 in a random access memory (RAM) buffer (not shown in FIG. 1).

The file management unit 130 records the content data stored in the RAM buffer for a certain page size unit on the flash memory recording media 160, 161, and 162 via the virtual device control unit 140 and the device control units 150, 151, and 152.

The virtual device control unit 140 virtualizes the flash memory recording media 160, 161, and 162 as a single virtual device. This allows the virtual device control unit 140 to provide the file management unit 130 with addressable memory areas without concerning memory boundaries between the flash memory recording media. It should be noted that the virtual device control unit 140 may control, as a single virtual device, at least a part of the memory area of the first flash memory recording medium and at least a part of the memory area of the second flash memory recording medium among the flash memory recording media 160, 161, and 162. Moreover the virtual device control unit 140 may control, as a single virtual device, at least a part of the memory area of the first flash memory recording medium, at least a part of the memory area of the second flash memory recording medium, and at least a part of the memory area of a third flash memory recording medium among the flash memory recording media 160, 161, and 162.

Here, the data recording device 100 that includes three flash memory recording media will be described, but the data recording device 100 may include two or more flash memory recording media.

The device control units 150, 151, and 152 are device drivers that control the operations of the flash memory recording media 160, 161, and 162 and also control real data transfer. The flash memory recording media 160, 161, and 162 are large scale integrated circuits (LSIs) suitable to be embedded that include a flash memory chip such as an embedded SD card or an embedded multimedia card (MMC) and a controller of the flash memory card.

Moreover, the file management unit 130 performs the programming process and the erasing process in parallel. Here, the programming process is a process of programming data in a memory area included in the virtual device and the first flash memory recording medium. Moreover, the erasing process is a process of erasing the data from a memory area included in the virtual device and the second flash memory recording medium to create a free area to be a programming destination in the subsequent programming process.

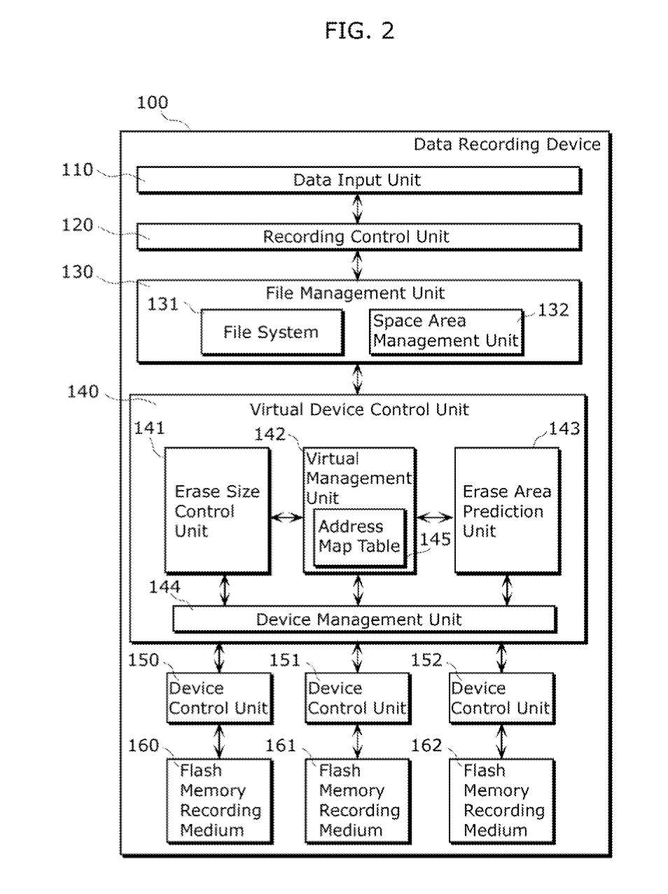

With reference to FIG. 2, the virtual device control unit 140 and the file management unit 130 will be described that are features in the first embodiment of the present invention.

FIG. 2 illustrates a detailed configuration of the data recording device 100 according to the first embodiment of the present invention.

As shown in FIG. 2, the virtual device control unit 140 includes an erase size control unit 141, a virtual management unit 142, an erase area prediction unit 143, and a device management unit 144. Each functional block performs a specific function thereof while sharing an address map table 145 and performance information on the flash memory recording media among functional blocks.

The device management unit 144 collectively manages device-specific information on each flash memory recording medium that is obtained by the device control units 150, 151, and 152. Here, the device-specific information includes a memory capacity, an erase unit, and a transfer rate of a flash memory recording medium.

The virtual management unit 142 integrates the memory capacities of the flash memory recording media 160, 161, and 162. Moreover, the virtual management unit 142 assigns logical addresses to each flash memory recording medium. Moreover, the virtual management unit 142 creates and manages the address map table 145. The address map table 145 is an implementation of address translation information. Moreover, the virtual management unit 142 refers to the address map table 145 for logical addresses specified as a programming location by the file management unit 130 and identifies a flash memory recording medium to be a programming destination (hereinafter referred to as a programming destination medium), converting the specified logical addresses into physical addresses. Moreover, the virtual management unit 142 programs in the converted physical addresses of the programming destination medium.

The erase size control unit 141 determines a memory size most suitable for erasing by an erasing process, according to a page size that is a programming unit for the file management unit 130.

Specifically, the erase size control unit 141 obtains from the device management unit 144, each erase unit size of the flash memory recording media or a size of a data-erased area that can guarantee a constant recording rate (minimum rate guaranteed unit size: e.g., for an embedded SD card, allocation unit size). The erase size control unit 141 calculates, as an erase size, a memory size that is a common multiple of the above-mentioned page size and each erase unit size of the flash memory recording media. It should be noted that the erase size control unit 141 may calculate, as an erase size, a memory size that is a common multiple of the above-mentioned page size and each of the minimum rate guaranteed unit size of the flash memory recording media.

Moreover, the file management unit 130 performs the data erasing process using the erase size determined by the erase size control unit 141.

When the programming process is performed, the erase area prediction unit 143 determines on which one of the flash memory recording media 160, 161, and 162 the erasing process is performed. Specifically, when the file management unit 130 specifies logical addresses of the programming location, the erase area prediction unit 143 selects a flash memory recording medium different from a programming destination medium as a flash memory recording medium in which the erasing process is to be performed (hereinafter referred to as an erasing destination recording medium). Moreover, the erase area prediction unit 143 determines a data erasable area that is a range of erasable logical address among the memory areas of an erasing destination recording medium It should be noted that the erasing destination recording medium is used for the subsequent programming process after the erasing process. Therefore, conditions to select the erasing destination recording medium may be set in advance for the erase area prediction unit 143, and the erase area prediction unit 143 may select the erasing destination recording medium based on the selection information.

As an example of the above selection conditions, it is possible to set a selection condition that “a programming speed is slow” in a data recording device to which the flash memory recording media that can program at high speed and the flash memory recording media that programs at low speed are connected. In this case, the erase area prediction unit 143 preferentially selects a flash memory recording medium having a high programming speed (i.e., the time to perform the programming process is short), and the file management unit 130 is notified of the logical addresses of the selected flash memory recording medium as a range where data is to be erased. It should be noted that the erase area prediction unit 143 may preferentially select a flash memory recording medium having a high erasing speed (the time to perform the erasing process is short).

Likewise, in the data recording device to which the flash memory recording media having uneven frequency of usage (the number of rewrites) are connected, a selection condition may be set that a flash memory recording medium having “lower frequency of usage” is preferentially selected.

Moreover, the file management unit 130 performs, in parallel, the programming process, and the erasing process on the erasing destination recording medium that is determined by the erase area prediction unit 143.

This file management unit 130 includes a file system 131. Moreover, the file management unit 130 accesses, using one file system 131, the virtual device in which the flash memory recording media are virtualized as a single recording medium. Moreover, the file management unit 130 may include a free area management unit 132 to manage a data-erased free area.

The free area management unit 132 manages information on a data-erased area indicating a memory area (free area) where the erasing process is completed, and appropriately updates the information on the data-erased area for the erasing-process completed area.

Moreover, the file management unit 130 can sequentially or simultaneously requires the virtual device control unit 140 to perform the programming and erasing processes. When requiring the erasing process, the file management unit 130 selects an erase area from erase target areas that are specified by the erase area prediction unit 143, and manages an area where the erasing process is completed as a programming area (free area) in the subsequent recording process.

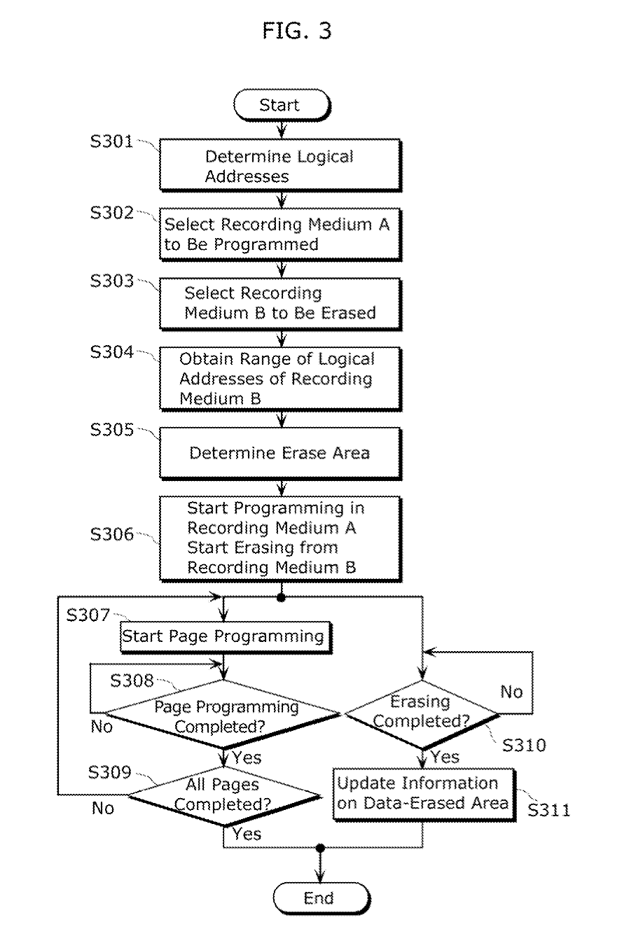

A data recording method of the data recording device 100 will be described with reference to the flowchart in FIG. 3.

The flash memory recording media used here are defined as a recording medium A and a recording medium B. Moreover, the virtual device control unit 140 virtualizes the recording medium A and the recording medium B as a single virtual device. Here, the recording medium A has a free area and the free area is selected as a start location of the programming process. Moreover, the recording medium B has little free area and a recording speed slows down unless the erasing process is performed. Moreover, recording data means stream data for which high-speed and sequential recording is required.

The file management unit 130 determines logical addresses of the virtual device as a programming location from the free areas, and notifies the virtual device control unit 140 of the determined logical addresses of the virtual device (S301).

The virtual management unit 142 of the virtual device control unit 140 selects the programming target recording medium A from the notified logical addresses, using the address map table 145, and determines a physical address that is a start location to program in the recording medium A (S302).

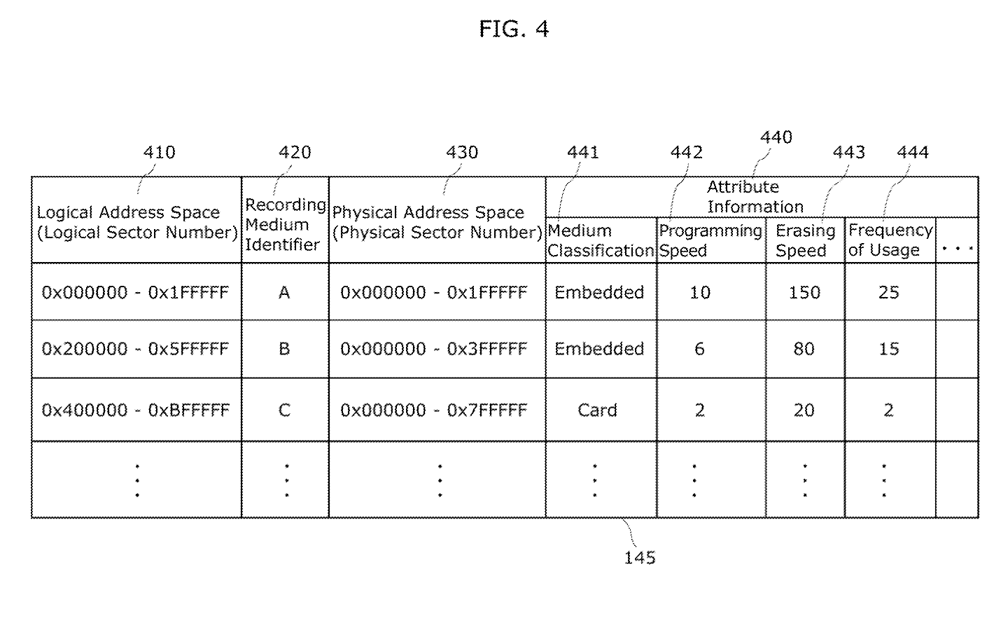

FIG. 4 shows a configuration example of the address map table 145. The address map table 145 includes logical address spaces 410, each of which covers a certain range, corresponding recording medium identifiers 420 and corresponding physical address spaces 430 for the logical address spaces 410. Moreover, the address map table 145 may include attribute information 440 of the flash memory recording medium corresponding to the logical address spaces 410. The attribute information 440 includes conditions such as a medium classification 441, a programming speed 442, an erasing speed 443, and a frequency of usage 444 (the number of programming times), that are used when a flash memory recording medium is selected

The erase area prediction unit 143 selects the recording medium B different from the recording medium A as an erasing destination recording medium (S303). Here, for the data recording device 100 to which three or more flash memory recording media are connected, the erase area prediction unit 143 may preferentially select, as the erasing destination recording medium, a flash memory recording medium suitable for the purpose of the data recording device 100 according to a previously-set condition (such as programming speed or the number of programming times). It should be noted that when the address map table 145 has the attribute information 440, the erase area prediction unit 143 may obtain device information by referring to the attribute information 440 shown in the address map table 145 instead of obtaining the device information from the device management unit 144. Here, the device information s used for the conditions to select an erasing destination recording medium.

The erase area prediction unit 143 refers to the address map table 145 and obtains a range of data-erasable logical addresses assigned to the recording medium B to determine the obtained range of the logical addresses as a data-erasable area. Moreover, the erase area prediction unit 143 notifies the file management unit 130 of the determined data-erasable area (S304).

The file management unit 130 determines an area to be used for the subsequent programming from the notified data-erasable area. Moreover, the file management unit 130 notifies the virtual device control unit 140 of an erase start address as an erase area that is the determined area (S305).

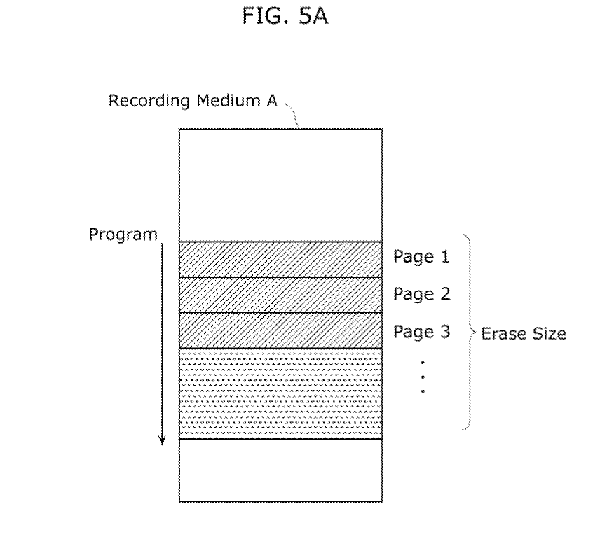

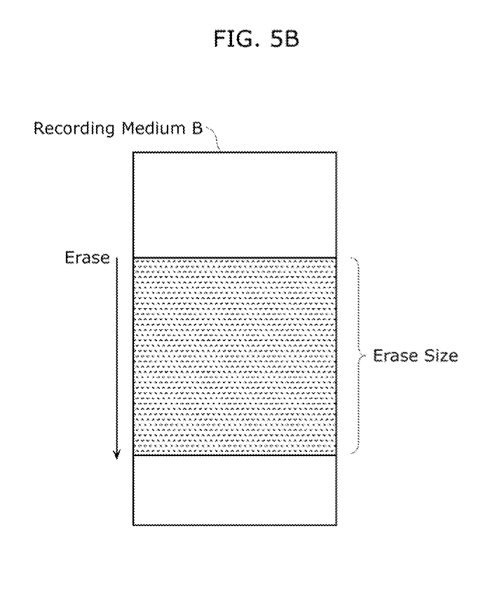

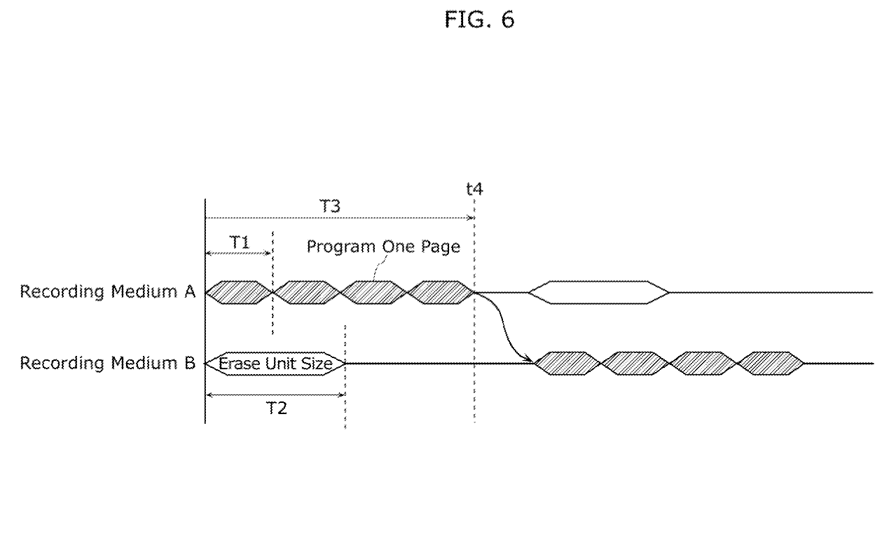

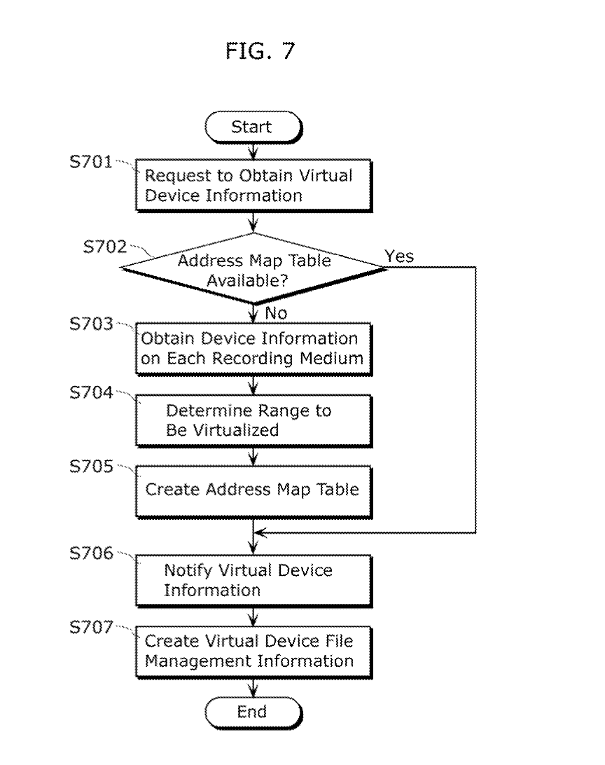

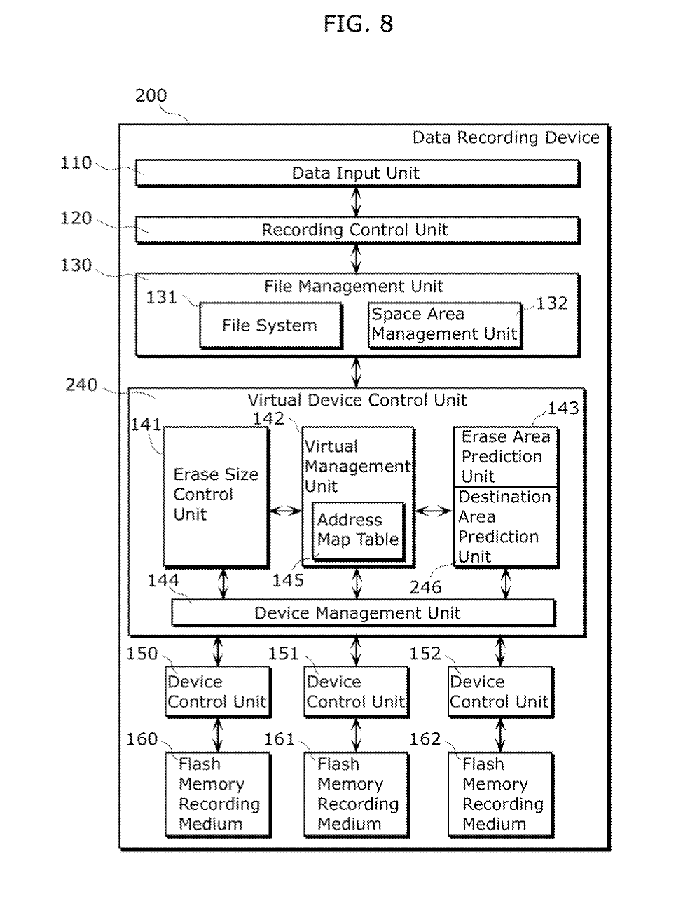

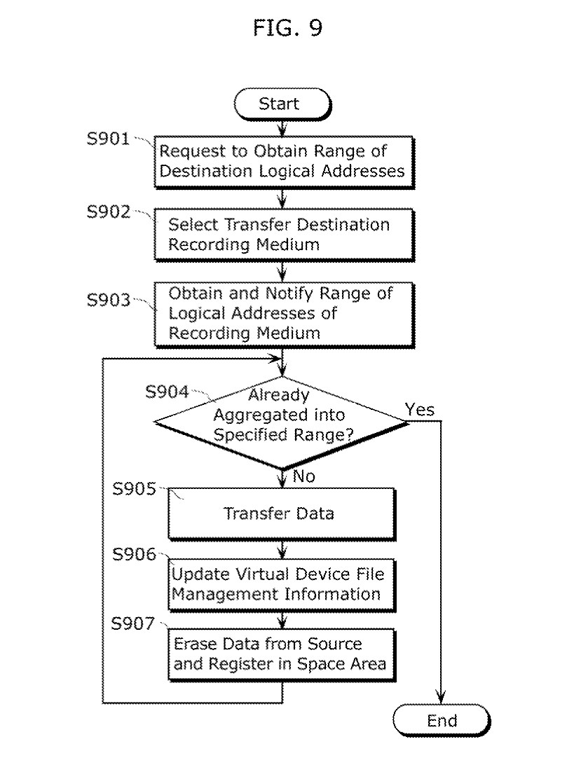

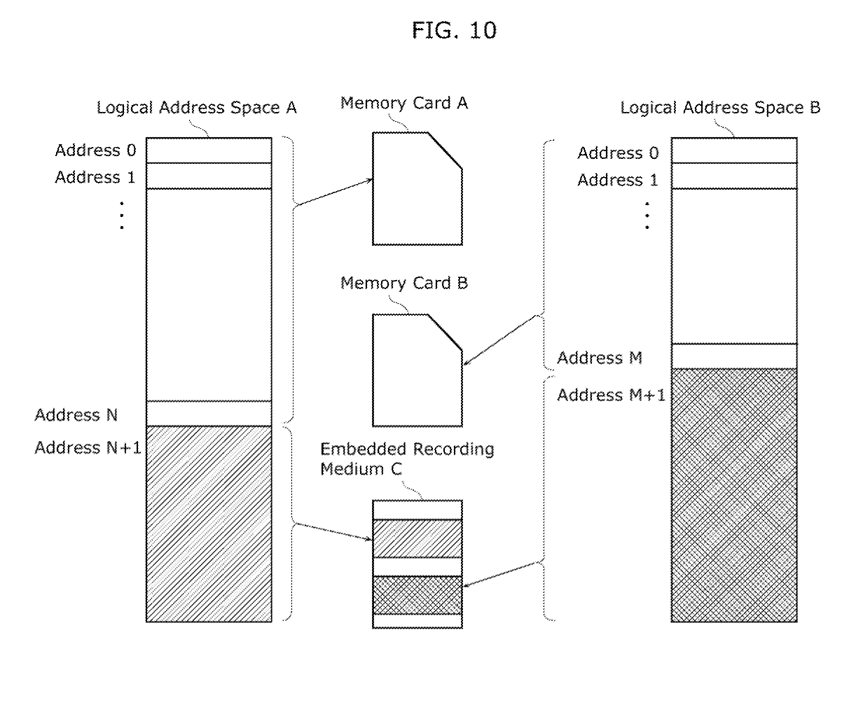

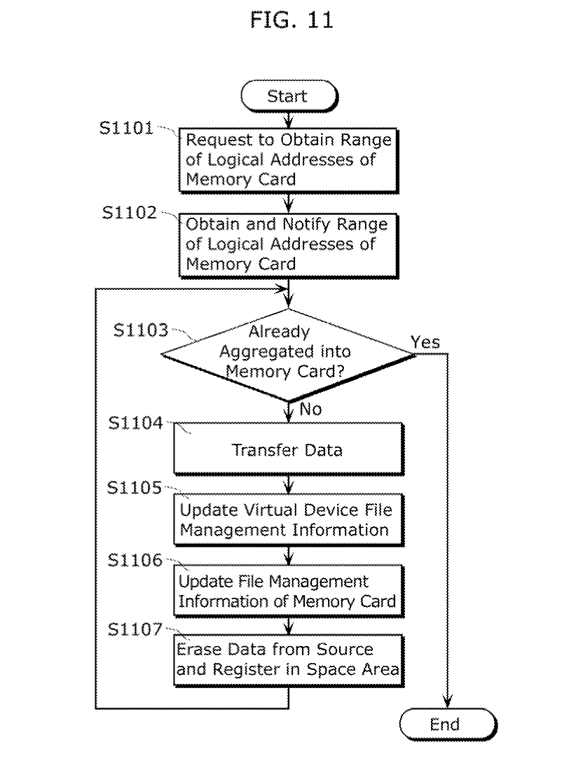

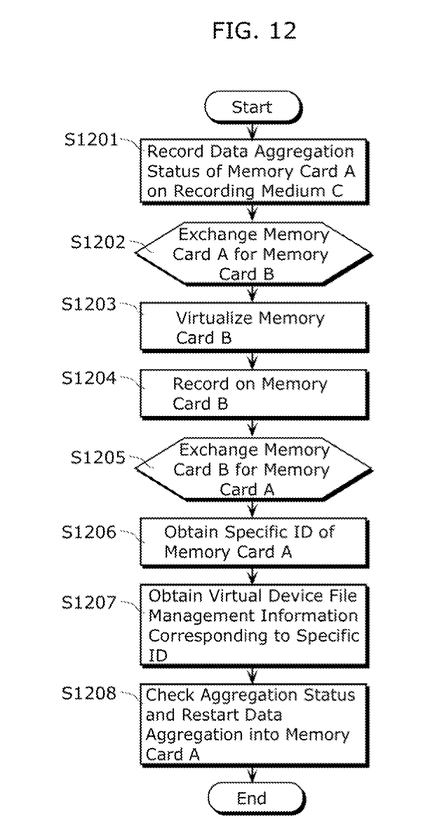

As shown in FIGS. 5A and 5B, the virtual device control unit 140 performs the programming process of data of each page on the recording medium A and the erasing process of an erase size on the erase area of the recording medium B through the device control units (S306).

Here, the programming process and the erasing process of the flash memory recording medium are often performed by the command method. Thus, it is possible to simultaneously perform on different flash memory recording media, the programming process that combines a direct memory access (DMA) transfer process and a command process, and the erasing process that is performed only by the command process. Moreover, since an erase size covers a plurality of page sizes, time T2 required for an erasing process may be longer than time T1 required for the programming process of one page as shown in FIG. 6. However, time T2 for the erasing process is shorter than time T3 for the programming process of the data ranging the number of pages that is equal to the erase size. Thus, the erasing process for the memory area to be used in the subsequent programming is completed by time t4 when programming data of the pages that are equal to the erase size is completed using a free area where programming is being performed. This allows the data recording device 100 according to the first embodiment of the present invention to continue programming soon after the programming destination is changed from the recording medium A to the recording medium B.

Specifically, when receiving a notification of the completion of programming and erasing from the device control units 150, 151, or 152, the virtual device control unit 140 notifies the file management unit 130 of the completion of programming and erasing. After a process of programming one-page data is started (S307), when notified that the process of programming one-page data is completed (Yes at 5308), the file management unit 130 determines whether or not the programming process of data of all pages is completed (5309).

When the programming process of the data of all pages is not completed (No at S309), the file management unit 130 starts the programming process of the next page (S307).

Moreover, when receiving a notification of erase completion (Yes at S310), the free area management unit 132 manages the data-erased area as a free area (S311).

Moreover, when the entire free area of the erase size where programming is being performed is used up, the file management unit 130 programs the subsequent pages in a free area managed by step S311 (e.g the free area of the recording medium B).

Repeating a series of steps of the above flowchart allows the data recording device 100 according to the first embodiment of the present invention to program in a data-erased memory area (free area) at any time using two or more flash memory recording media, thereby allowing high-speed recording to be achieved.

Moreover, in step S343, if a condition that “programming speed is high” is set for the erase area prediction unit 143, as a condition to select a data-erasable area, the erase area prediction unit 143 selects a recording medium with a high programming speed from the flash memory recording media. Thus, since only high-speed recordable flash memory recording media are preferentially used, continuously faster recording process is made possible.

Moreover, in step S303, if a condition that “frequency of usage is low” is set as a condition to select the data-erasable area for the erase area prediction unit 143, the erase area prediction unit 143 selects a recording medium having smaller number of programming times from the flash memory recording media. This can level out the frequency of usage among the flash memory recording media, thus allowing performance balancing of the recording media to be maintained.

Peripheral processing will be described below that is required for performing a data recording method according to the first embodiment of the present invention.

Here, the following describes creation, obtainment, and update processing of virtual device file management information that is used by the file management unit 130.

Since file management information is applied to the virtual device, the virtual device file management information has a same configuration as conventional file management information. Here, the file management information is a file management table or bitmap information. Specifically, focusing on file allocation table (FAT) file systems used by a SD memory card as an example, master boot record, FDC descriptor, file allocation table or the like corresponds to the virtual device file management information. This virtual device file management information is generally created during format processing of a recording medium, and is recorded on either one of the flash memory recording media 160, 161, and 162.

A creation procedure of the virtual device file management information will be described with reference to the flowchart in FIG. 7.

The file management unit 130 requires the virtual device control unit 140 to obtain virtual device information such as a memory capacity (S701).

After receiving the request, the virtual management unit 142 checks whether the virtual management unit 142 has the address map table 145 (S702). Here, when the virtual management unit 142 has the address map table 145 (Yes at S702), virtualization is already performed at the virtual device control unit 140. Therefore, the virtual management unit 142 notifies the file management unit 130 of the virtual device information that is managed by itself or included in the address map table 145 (S706).

On the other hand, when the virtual management unit 142 does not have the address map table 145 (No at S702), virtualization is not performed at the virtual device control unit 140. Therefore, the device management unit 144 obtains device information on the flash memory recording media (S703).

The virtual management unit 142 determines a range of the memory areas (range to be virtualized) of a recording medium and recording media to be virtualized (S704).

The virtual management unit 142 creates the address map table 145 after integrating device information on the area to be virtualized and assigning logical addresses of the flash memory recording media to physical addresses (S705). At this time, the virtual device control unit 140 may incorporate information included in the device information into the address map table 145 as the attribute information 440. Moreover, the virtual device control unit 140 may store the address map table 145 in an external memory, or the virtual device control unit 140 determines that a part of the memory area of a specific flash memory recording medium is not to be virtualized during virtualization, and may store the address map table 145 in the part of the memory area that is not to be virtualized.

After the completion of creating the address map table 145, the virtual device control unit 140 notifies the file management unit 130 of the virtual device information (S706).

The file management unit 130 creates the virtual device file management information based on the notified virtual device information, and records on the virtual device, the created virtual device file management information (S707). Moreover, when re-virtualization is performed at the virtual device control unit 140, the virtual management unit 142 may create a new address map table 145 and reassign the physical memory addresses.

Moreover, when the virtual device control unit 140 obtains the virtual device file management information that is already recorded on the flash memory recording medium, the file management unit 130 specifies logical addresses on which virtual device file management information is recorded. Thus, the virtual device control unit 140 converts the specified logical addresses into the physical addresses, referring to the address map table 145, and obtains the virtual device file management information.

Moreover, the virtual device file management information can be updated in the same way as the update of the file management information in the conventional file system. For instance, after specific synchronization timing and completion of recording, update recording is performed for a virtual device.

Thus, the data recording device 100 according to the first embodiment of the present invention performs, in parallel, the programming process on the recording medium A and the erasing process on the recording medium B.

This allows the data recording device 100 according to the first embodiment of the present invention to program data in a data-erased area at any time. Therefore, the data recording device 100 according to the first embodiment of the present invention can record data at a high speed, while keeping a certain speed. Thus, the data recording device 100 according to the first embodiment of the present invention, for example, can avoid failing to record due to the performance of a flash memory recording medium during streaming recording of high quality picture data and large volume data. Moreover, the data recording device 100 according to the first embodiment of the present invention can reduce programming buffer size prepared on the RAM.

Moreover, when performing the programming process, the data recording device 100 according to the first embodiment of the present invention follows predetermined conditions and determines on which flash memory recording medium the data recording device 100 performs the erasing process among the flash memory recording media.

Thus, the data recording device 100 according to the first embodiment of the present invention can select from the flash memory recording media, a flash memory recording medium having the most suitable performance for system requirements or content types, and program therein.

Moreover, when performing the programming process, the data recording device 100 according to the first embodiment of the present invention determines a flash memory recording medium on which the erasing process is to be performed from among the flash memory recording media, the flash memory recording medium being a flash memory recording medium for which the number of times at which rewriting is performed is smaller.

Thus, the data recording device 100 according to the first embodiment of the present invention can program data in a flash memory recording medium having low frequency of programming. Thus, the data recording device 100 according to the first embodiment of the present invention can uniformly keep degradation of the flash memory recording media.

Moreover, when performing the programming process, the data recording device 100 according to the first embodiment of the present invention determines a flash memory recording medium on which the erasing process is to be performed from among the flash memory recording media, the flash memory recording medium being a flash memory recording medium on which it takes less time to complete the erasing process.

Thus, the data recording device 100 according to the first embodiment of the present invention can record data on the flash memory recording medium with a high erasing speed. Thus, the data recording device 100 according to the first embodiment of the present invention can keep a certain erasing speed when high speed recording is required to record, for example, large volume content.

Moreover, when performing the programming process, the data recording device 100 according to the first embodiment of the present invention determines a flash memory recording medium on which the erasing process is to be performed from among the flash memory recording media, the flash memory recording medium being a flash memory recording medium on which it takes less time to complete the programming process.

Thus, the data recording device 100 according to the first embodiment of the present invention can program data in a flash memory recording medium with a high programming speed. Thus, the data recording device 100 according to the first embodiment of the present invention can keep a recording speed when high speed recording is required to record, for example, large volume content.

The data recording device 100 according to the first embodiment of the present invention determines an erase size that is an erase unit based on a page size that is a programming unit.

Thus, the data recording device 100 according to the first embodiment of the present invention can select the most suitable erase size for the erasing process. Moreover, the data recording device 100 according to the first embodiment of the present invention determines, as an erase size, a common multiple of a page size and each erase unit size of the flash memory recording media, or a common multiple of a page size and each of the minimum rate guaranteed unit sizes of the flash memory recording media.

Thus, the data recording device 100 according to the first embodiment of the present invention can calculate the erase size that can be commonly used for the flash memory recording media. As a result, it is unnecessary to mange erase size among the flash memory recording media. Thus, the data recording device 100 according to the first embodiment of the present invention can efficiently mange a memory by using the calculated erase size as a minimum management unit when a data-erased area is managed.

Moreover, the data recording device 100 according to the first embodiment of the present invention manages data-erased area information together with file management information, and appropriately updates the data-erased area information for the area where the erasing process is completed.

Thus, the data recording device 100 according to the first embodiment of the present invention can easily distinguish a data-erased area from a data-unerased area in the memory area of the virtual device. Therefore, the data recording device 100 according to the first embodiment of the present invention can efficiently select a memory area for the next programming process and a memory area for the next erasing process.

### Embodiment 2

In the second embodiment of the present invention, the configuration of a data recording device and a data recording method will be described that have extended functions of the data recording device and the data recording method of the first embodiment.

FIG. 8 illustrates the configuration of a data recording device 200 according to the second embodiment of the present invention.

The configuration of a virtual device control unit 240 of the data recording device 200 shown in FIG. 8 is different from that of a virtual device control unit 140 of the data recording device 100 shown in FIG. 2. Specifically, in addition to the configuration of the virtual device control unit 140, the virtual device control unit 240 further includes a transfer destination area prediction unit 246. It should be noted that the same reference numerals are given to the same elements as FIG. 2 and overlapped explanation is omitted.

The transfer destination area prediction unit 246 selects a flash memory recording medium to be a data destination (hereinafter referred to as transfer destination recording medium) from flash memory recording media 160, 161, and 162, based on previously set conditions, and has a function to determine a range of logical addresses of the selected flash memory recording medium.

Here, after completion of recording data, a file is often divided and recorded on the flash memory recording media. The data recording device 200 according to the second embodiment of the present invention performs a data aggregating process by which the fragmented pieces of data are transferred to one flash memory recording medium. Specifically, the file management unit 130 performs the data aggregating process by transferring the file which is divided and recorded on the flash memory recording media to a transfer destination recording medium determined by the transfer destination area prediction unit 246 and erasing the transferred data from the source recording medium from which data is transferred.

Moreover, a series of steps of the data recording method in the second embodiment is the same as that of the flowchart in FIG. 3. It should be noted that in the present embodiment, as a result of performing stream recording using the above data recording method, the file or data is divided and recorded on the flash memory recording media.

The above data aggregating process by the data recording device 200 according to the second embodiment of the present invention will be described with reference to FIG. 9,

During CPU waiting time after completion of recording, the file management unit 130 requires the virtual device control unit 240 to notify a range of logical addresses to transfer a recorded file (S901).

The transfer destination area prediction unit 246 selects a transfer destination recording medium based on previously set conditions, referring to, for example, attribute information 440 shown in an address map table 145 (S902).

The transfer destination area prediction unit 246 extracts from the address map table 145, the range of the logical addresses of the memory area that is assigned to the transfer destination recording medium, and notifies the file management unit 130 of the extracted range of the logical addresses (S903).

The file management unit 130 checks the status of data aggregation into the specified logical addresses (S904). When the process of aggregating data into the specified logical addresses is not completed (No at S904), the file management unit 130 transfers the data to the specified logical addresses (S905). Moreover, the file management unit 130 updates virtual device file management information (S906). The file management unit 130 performs an erasing process on a data area from which data is transferred, and manages a data-erased area as a free area (S907).

At this time, if a flash memory recording medium in which programming and erasing processes are performed at a low speed is set in advance as a condition to select a data destination for the transfer destination area prediction unit 246, it is possible to reserve a data-erased free area of a flash memory recording medium with high-speed programming and erasing. Therefore, in the flash memory recording medium 200 that combines a high-speed programmable flash memory recording medium and a flash memory recording medium with low-speed programming, a free area is created in the high-speed programmable flash memory recording medium by transferring programmed data to the flash memory recording medium with low-speed programming during CPU waiting time after completion of programming. Thus, data can be programmed in the high-speed programmable flash memory recording medium in the subsequent programming process,

In other words, the transfer destination area prediction unit 246 may select a flash memory recording medium that needs a long period of time for the erasing process as the transfer destination recording medium from the flash memory recording media.

Moreover, the transfer destination area prediction unit 246 may select a flash memory recording medium that needs a long period of time for the programming as a transfer destination recording medium from the flash memory recording media.

As mentioned above, the data recording device 200 according to the second embodiment of the present invention can maintain a high recording speed by performing the data aggregating process according to the present invention in combination with the data recording process according to the present invention. Moreover, the data recording device 200 according to the second embodiment of the present invention can have more choices when choosing a flash memory recording medium suitable for the intended purpose of the data recording device 200.

Moreover, the data recording device 200 according to the second embodiment of the present invention determines a transfer destination recording medium from flash memory recording media 160, 161, and 162, based on the predetermined conditions. Moreover, the data recording device 200 transfers to the determined transfer destination recording medium, the file that is divided and recorded on the flash memory recording media 160, 161, and 162 and performs the data aggregating process by which data stored on the recording medium from which data is transferred is erased.

As a result, the data recording device 200 according to the second embodiment of the present invention can aggregate the file that is recorded in a fragmented way into one place by transferring data between the flash memory recording media during, for example, CPU waiting time after completion of recording. This allows the data recording device 200 according to the second embodiment of the present invention to improve efficiency of file management.

### Embodiment 3

The third embodiment of the present invention describes a case when the data recording device and the data recording method according to the second embodiment are applied to a memory card.

In the third embodiment of the present invention, one of the flash memory recording media 160, 161, and 162 shown in FIG. 8 is a memory card that is a flash memory recording medium removable from the data recording device 200. Moreover, a memory card can be specified as a recording device by an external device of the data recording device 200.

It should be noted that the configuration of the data recording device 200 according to the third embodiment of the present invention is the same as that shown in FIG. 8. Moreover, a series of steps of the data recording method is the same as that shown in Fig.

The following mainly describes differences from the second embodiment.

Here, a procedure of virtualization including the format of the memory card and creation of virtual device file management information is the same as the flowchart shown in FIG. 7. However, the virtual device file management information is recorded on logical addresses assigned to the memory card.

Specifically, when the system is shutdown or memory card is removed, the file management unit 130 records on the memory card, the virtual device file management information that is file management information of the virtual device together with file management information of the memory card itself.

Moreover, after the system is restarted or when the memory card is reinserted, the file management unit 130 obtains the virtual device file management information from the memory card, and checks whether or not a data aggregating process is completed using the data destination memory card.

Moreover, when the data aggregating process is not completed using the data destination memory card, the file management unit 130 performs the data aggregating process using the data destination memory card.

Moreover, the file management unit 130 updates the file management information of the memory card itself according to the status of the data aggregating process using the data destination memory card.

Moreover, when a group of the flash memory recording media including the memory card is virtualized, (i) all of the flash memory recording media may be virtualized as a single virtual device, or (ii) the combination of the memory card and a part of the group of the flash memory recording media other than the memory card may be virtualized, or (iii) the combination of the memory card and a part of the memory area of a flash memory recording medium may be virtualized.

Moreover, in the data aggregating process, the transfer destination area prediction unit 246 selects the memory card as a transfer destination recording medium from the flash memory recording media.

Moreover, when the memory card is specified as a recording destination for continuous recording or stream recording from an external device (e.g., a superior function block of the file management unit 130), and data size recorded on the entire virtual device is equal to the capacity of memory card, the file management unit 130 notifies the external device that the memory card has no available space. Moreover, the file management unit 130 performs the data aggregating process using the data destination memory card. It should be noted that the flash memory recording media 160, 161, and 162 are a memory card A, a memory card B, and an embedded recording medium C, respectively.

FIG. 10 illustrates an example of a case when the combination of the memory card and a part of the memory area of the embedded recording medium is virtualized. FIG. 10 illustrates a logical address space A and a logical address space B when the memory card A and the memory card B each having an assigned part of the memory area of the embedded recording medium C are virtualized. At this time, the data recording device 200 uses, as a work memory, a virtual memory area assigned from a recording medium other than the memory card, and performs the data recording process shown in FIG. 3.

The flowchart shown in FIG. 11 shows a procedure of data aggregation into the memory card after completion of recording,

During CPU waiting time after completion of recording, the file management unit 130 requires the virtual device control unit 240 to notify a range of the logical addresses of the memory card to be a data destination (S1101).

The transfer destination area prediction unit 246 searches the specified memory card, referring to, for example, attribute information 440 of an address map table 145. Moreover, the transfer destination area prediction unit 246 extracts, from the address map table 145, a range of logical addresses that corresponds to a physical address space of the searched memory card, and notifies the file management unit 130 of the range of the extracted logical addresses (S1102).

The file management unit 130 checks the status of data aggregation into the specified logical addresses (S1103). When the data aggregation into the specified logical addresses is not completed (Not at S1103), the file management unit 130 transfers the data to the specified logical addresses (S1104), and then updates the virtual device file management information (S1105). Moreover, the file management unit 130 also updates the file management information of the memory card itself (S1106). Moreover, the file management unit 130 performs an erasing process on the transferred data stored on the source recording medium, and manages a data-erased area as a free area (S1107).

Here, a flag indicating status of completion or incompletion of aggregation may be used for checking the status of data aggregation of step S1103. Specifically, when the data aggregation into the virtual device is completed, the file management unit 130 sets the above flag and records on the memory card, the flag and the virtual device file management information. Moreover, when checking the status of aggregation when the system is restarted or the memory card is reinserted, the file management unit 130 first checks the status of the above flag. Thus, if the aggregation process is already completed, the file management unit 130 does not have to search the file management information, for example, by FAT chain search. This allows the speed up of the checking process. Moreover, to restart checking the status of aggregation after the aggregation process is stopped, the file management unit 130 may have logical address information on a restart location of research along with the above flag. Also in this case, the aggregation is efficiently restarted when the aggregation is not completed.

Moreover, the order of step S1105 and step S1105 may be reversed.

Moreover, the file management unit 130 temporarily reserves, as a work memory, at least a part of the memory area of the flash memory recording medium other than the memory card. The file management unit 130 may manage the memory card and the work memory area as a single virtual device, using the virtual device file management information. In this case, when the process of data aggregation into the memory card is completed when the system is shutdown or the memory card is removed, the file management unit 130 may unlock the virtualization and make the above work memory available by abandoning the virtual device file management information, This enables efficient utilization of the memory area.

As mentioned above, the data recording device 200 according to the third embodiment of the present invention performs a process of file aggregation into the above memory card. This allows the file recorded on the data recording device 200 to be used in other play back equipment and the like via the memory card.

Moreover, the data recording device 200 according to the third embodiment of the present invention manages the virtual device file management information in the memory card. Thus, even when the memory card is removed with the data aggregation into the memory card being uncompleted, when memory card is reinserted into the data recording device 200, the data recording device 200 can check the status of data aggregation using the virtual device file management information obtained by the memory card. Thus, the data recording device 200 according to the third embodiment of the present invention can restart aggregating data into the memory card.

Moreover, performance such as a memory capacity and a recording speed of the virtual device can be easily changed in accordance with the change of memory card inserted into the data recording device 200. Therefore, it is possible to achieve a flexible device configuration according to the intended use of the data recording device 200.

### Embodiment 4

The fourth embodiment of the present invention describes an example different from the third embodiment when a memory card is used.

In the fourth embodiment of the present invention, one of flash memory recording media 160, 161, and 162 is a memory card as same as the third embodiment. Moreover, a memory card can be specified as a recording device by the external device of the data recording device 200.

Moreover, the memory card to be inserted into the data recording device 200 has a unique ID so as to be uniquely identified. For instance, a card identification (CID) in a SD memory card or a MMC corresponds to the unique ID.

It should be noted that the configuration of the data recording device 200 according to the fourth embodiment is the same as that shown in FIG. 8. Moreover, a series of steps of the data recording method is the same as that shown in FIG. 3. The following mainly describes differences from the third embodiment.

Here, a procedure of virtualization including the format of he memory card and creation of virtual device file management information is the same as the flowchart shown in FIG. 7 as same as the third embodiment. However, unlike the third embodiment, logical addresses assigned to recording media other than the memory card are recording destinations of virtual device file management information. For instance, the data recording device 200 to which a SD memory card and embedded SD cards are connected records the virtual device file management information on the memory area that is virtualized and assigned to the embedded SD card.

Moreover, the data recording device 200 records on the above memory area, the unique ID of the memory card together with the virtual device file management information. When obtaining the virtual device file management information, the data recording device 200 first obtains the unique ID from the memory card, and then obtains the corresponding virtual device file management information.

Specifically, when the system is shutdown or the memory card is removed, the file management unit 130 records the virtual device file management information together with the unique ID on a flash memory recording medium other than the memory card.

Moreover, after the system is restarted or when the memory card is reinserted, the file management unit 130 obtains the unique ID from the memory card. Moreover, the file management unit 130 obtains the virtual device file management information corresponding to the unique ID from the flash memory recording medium other than the memory card.

The file management unit 130 checks whether or not a data aggregating process is completed using the data destination memory card.

Moreover, when the data aggregating process is not completed using the data destination memory card, the file management unit 130 performs the data aggregating process using the data destination memory card. Moreover, the file management unit 130 updates the file management information of the memory card itself according to the status of the data aggregating process using the data destination memory card.

Moreover, the procedure of the process of data aggregation into the memory card when recording is completed is almost the same as that shown in FIG. 11 illustrating the third embodiment. However, a difference is in that the recording destination of the virtual device file management information in step S1105 is not the memory card but the recording medium other than the memory card.

Moreover, the fourth embodiment of the present invention assumes that memory cards are switched

Moreover, when virtualizing a group of the recording media, the data recording device 200 according to the fourth embodiment of the present invention may virtualize all of the flash memory recording media as a single virtual device. Moreover, the data recording device 200 may virtualize the combination of the memory card and a part of a group of the flash memory recording media other than the memory card, or may virtualize the combination of the memory card and a part of the memory area of a flash memory recording medium In this case, the data recording device 200 uses, as a work memory, a virtual memory area assigned by the recording medium other than the memory card, and performs the data recording process shown in FIG. 3.

Thus, the data recording device 200 according to the fourth embodiment can obtain the same effect as the third embodiment. Moreover, in the fourth embodiment of the present invention, the virtual device file management information is recorded on a recording medium other than the memory card. Thus, the data recording device 200 according to the fourth embodiment of the present invention can prevent the corruption of the virtual device file management information even if the memory card is suddenly removed during updating the file management information, for example, during recording or aggregating data. Thus, the data recording device 200 according to the fourth embodiment of the present invention can protect file system. Moreover, the data recording device 200 according to the fourth embodiment records on a recording medium other than the memory card, the unique ID of the memory card together with the virtual device file management information. This is for identifying cards when switching between memory cards. The following describes the procedure at the time with reference to FIG. 12.

The following describes that after the completion of recording on a memory card. A, the memory card A is replaced by a memory card B, and recording is continued with data aggregation uncompleted, and after that, data aggregation is restarted on the first memory card A. Moreover, the memory card A and a part of an embedded recording medium C fixedly connected to the data recording device 200 are virtualized and the virtual device file management information X together with a unique ID are both recorded on the recording medium C.

When the data recording device 200 is notified by, for example, an external device for detecting connection that the memory card A is removed, the data recording device 200 records on the recording medium C, the virtual device file management information X updated with current status of data aggregation (S1201). The memory card A is removed from the data recording device 200 and the memory card B is inserted into the data recording device 200 (S1202).

The data recording device 200 virtualizes parts of the memory card B and the memory card C, and creates virtual device file management information Y, and records the virtual device file management information Y together with a unique ID (S1203). Here, the data recording device 200 selects, as the memory area of the recording medium C, an area that is different from the area virtualized with the memory card A, referring to an address map table 145 used for the virtualization of the memory card A.

Moreover, the data recording device 200 continues recording data on the memory card B by the data recording method shown in FIG. 3 (S1204).

After the completion of recording on the memory card B, the memory card B is removed from the data recording device 200 and the memory card A is reinserted into the data recording device 200 (S1205).

The data recording device 200 obtains a unique ID from the memory card A (S1206), and obtains the virtual device file management information X corresponding to the unique ID from the recording medium C (S1207).

After checking the virtual device file management information X, the data recording device 200 restarts the process of data aggregation into the memory card A (S1208).

Moreover, when the process of data aggregation into the memory card B is not completed, the memory card B is replaced by another memory card, and the data aggregating process is performed in the same way. Moreover, as same as the third embodiment, when the memory card A is removed after the completion of the process of data aggregation into the memory card A, the data recording device 200 may abandon the virtual device file management information X and make the work memory area of the recording medium C available by unlocking the virtualization.

Moreover, a process to perform the virtualization process and the aggregation process for each memory card that is shown in FIG. 12 is a process required to continue high-speed recording while switching the memory cards in a recording device that needs memory cards such as a movie device using the data recording method according to the present invention.

Although the data recording device and the data recording method according to an embodiment of the present invention are described, the present invention is not limited to this embodiment.

Moreover, each processing unit included in the data recording device according to the first to fourth embodiments is typically achieved as LSI, i.e., an integrated circuit. There processing units can be in plural single-function LSIs, or also can be in one integrated LSI.

Moreover, ways to achieve integration are not limited to the LSI, and a special circuit or a general purpose processor may also achieve the integration. Field Programmable Gate Array (FPGA) that can be programmed after manufacturing LSI or a reconfigurable processor that allows re-configuration of the connection or configuration of a circuit cell in LSI can be used.

Furthermore, if integrated circuit technology that replaces LSI appears thorough progress in the semiconductor technology or other derived technology, that technology can naturally be used to carry out integration of the processing units.

Moreover, processors such as CPU may execute a program to achieve a part of or all of the functions of a data recording device according to the first to fourth embodiments of the present invention.

Moreover, the present invention may be the above program or a recording medium on which the above program is recorded.

Moreover, needless to say, the above program can be distributed via transmission media such as the Internet. Moreover, at least parts of the data recording device and the data recording method according to the first to fourth embodiments mentioned as above and modifications thereof may be combined.

Moreover, the order that steps included in the above data recording method are performed is indicated to specifically exemplify the present invention, and other orders may be possible. Moreover, a part of the above steps and another step may be performed simultaneously (in parallel).

Although only some exemplary embodiments of the present invention have been described in detail above, those skilled in the art will readily appreciate that many modifications are possible in the exemplary embodiments without materially departing from the novel teachings and advantages of the present invention. Accordingly, all such modifications are intended to be included within the scope of the present invention.

### INDUSTRIAL APPLICABILITY

The data recording device and the data recording method according to the present invention enable high-speed recording on a flash memory recording medium such as a SD memory card or an embedded SD card, and are useful for a recording device that includes flash memory recording media as an embedded memory or an external memory, for example, a digital still camera, a digital video camera, a recorder, and an audio device.

1. A data recording device for recording data on a first flash memory recording medium and a second flash memory recording medium, the data recording device comprising:
a virtual device control unit configured to control, as a single virtual device, at least a part of a memory area of the first flash memory recording medium and at least a part of a memory area of the second flash memory recording medium; and
a file management unit configured to perform a programming process and an erasing process in parallel, the programming process for programming data in a memory area included in the virtual device and the first flash memory recording medium, and the erasing process for erasing data from a memory area included in the virtual device and the second flash memory recording medium to generate a free area to be a programming destination in a subsequent programming process.

2. The data recording device according to claim 1,
wherein the data recording device is further configured to record data on a third flash memory recording medium, the virtual device control unit is configured to control, as the single virtual device, the at least a part of the memory area of the first flash memory recording medium, the at least a part of the memory area of the second flash memory recording medium, and at least a part of a memory area of the third flash memory recording medium,
the virtual device control unit includes an erase area prediction unit configured to determine on which one of the second flash memory recording medium and the third flash memory recording medium the erasing process is performed when the programming process is performed, and
the file management unit is configured to perform the programming process and an erasing process in parallel, the erasing process for erasing data from a memory area included in the virtual device and either the second flash memory recording medium or the third flash memory recording medium that is determined by the erase area prediction unit.

3. The data recording device according to claim 2,
wherein when the programming process is to be performed, the erase area prediction unit is configured to determine a flash memory recording medium on which the erasing process is to be performed, the flash memory recording medium being the second flash memory recording medium or the third flash memory recording medium for which the number of times at which rewriting is performed is smaller.

4. The data recording device according to claim 2,
wherein when the programming process is to be performed, the erase area prediction unit is configured to determine a flash memory recording medium on which the erasing process is to be performed, the flash memory recording medium being the second flash memory recording medium or the third flash memory recording medium on which it takes less time to complete the erasing process.

5. The data recording device according to claim 2,
wherein when the programming process is to be performed, the erase area prediction unit is configured to determine a flash memory recording medium on which the erasing process is to be performed, the flash memory recording medium being the second flash memory recording medium or the third flash memory recording medium on which it takes less time to complete the programming process.

6. The data recording device according to claim 1,
wherein the virtual device control unit includes an erase size control unit configured to determine an erase size, based on a page size, the erase size being an erase unit, the page size being a programming unit of the file management unit, and
the file management unit is configured to perform the erasing process using the erase size determined by the erase size control unit.

7. The data recording device according to claim 6,
wherein the erase size control unit is configured to determine, as the erase size, (i) a common multiple of the page size, an erase unit size of the first flash memory recording medium, and an erase unit size of the second flash memory recording medium, or (ii) a common multiple of the page size, a minimum rate guaranteed unit size of the first flash memory recording medium, and a minimum rate guaranteed unit size of the second flash memory recording medium.

8. The data recording device according to claim 1,
wherein the file management unit is configured to manage file management information and data-erased area information, and updates the data-erased area information to indicate a memory area where the erasing process is completed, the file management information being a file management table or bitmap information, and the data-erased area information indicating the memory area where the erasing process is completed.

9. The data recording device according to claim 1,
wherein the virtual device control unit includes a transfer destination area prediction unit configured to determine a data destination flash memory recording medium to which data is transferred from among the first flash memory recording medium and the second flash memory recording medium, and
the file management unit is configured to perform a data aggregating process by transferring a file divided and recorded on the first flash memory recording medium and the second flash memory recording medium to the first flash memory recording medium or the second flash memory recording medium that is determined by the transfer destination area prediction unit, and erasing transferred data from a recording medium from which data is transferred.

10. The data recording device according to claim 9,
wherein the transfer destination area prediction unit is configured to select a flash memory recording medium on which it takes more time to complete the erasing process from among the first flash memory recording medium and the second flash memory recording medium, as the data destination flash memory recording medium.

11. The data recording device according to claim 9,
wherein the transfer destination area prediction unit is configured to select a flash memory recording medium on which it takes more time to complete the programming process from among the first flash memory recording medium and the second flash memory recording medium, as the data destination flash memory recording medium.

12. The data recording device according to claim 9,
wherein the transfer destination area prediction unit is configured to select a memory card from among the first flash memory recording medium and the second flash memory recording medium as the destination flash memory recording medium, the memory card being the a flash memory recording medium removable from the data recording device.

13. The data recording device according to claim 12,
wherein when the memory card is specified as a destination of sequential recording or stream recording by an external device, and a data size recorded on the entire virtual device is equal to a capacity of the memory card, the file management unit is configured to notify the external device of the data recording device that the memory card has no available space, and also performs the data aggregating process using the memory card as the data destination.

14. The data recording device according to claim 12,
wherein the file management unit
is configured to record on the memory card, virtual device file management information together with file management information of the virtual device itself when a system is shutdown or the memory card is removed, the virtual device file management information being file management information of the virtual device,
is configured to obtain the virtual device file management information from the memory card after the system is restarted or when the memory card is reinserted,
is configured to check whether or not the data aggregating process is completed using the memory card as the data destination,
is configured to perform the data aggregating process using the memory card as the data destination when the data aggregating process in not completed using the memory card as the data destination, and
is configured to update the file management information of the memory card itself according to status of the data aggregating process using the memory card as the data destination.

15. The data recording device according to claim 12,
wherein the memory card includes a unique D so as to be uniquely identified,
the file management unit
is configured to record the virtual device file management information together with the unique ID on a flash memory recording medium that is not the memory card among the first flash memory recording medium and the second flash memory recording medium when a system is shutdown or the memory card is removed, the virtual device file management information being file management information of the virtual device,
is configured to obtain the unique ID from the memory card after the system is restarted or when the memory card is reinserted,
is configured to obtain the virtual device file management information corresponding to the unique ID from the flash memory recording medium that is not the memory card,
is configured to check whether or not the data aggregating process is completed using the memory card as the data destination,
is configured to perform the data aggregating process on the memory card as the data destination when the data aggregating process is not completed using the memory card as the data destination, and
is configured to update the file management information of the memory card itself according to status of the data aggregating process using the memory card as the data destination.

16. The data recording device according to claim 4,
wherein the file management unit
is configured to hold a flag indicating whether or not the data aggregating process is completed using the memory card as the data destination, and
is configured to check whether or not the data aggregating process is completed using the memory card as the data destination by referring to the flag.

17. The data recording device according to claim 14,
wherein the file management unit
is configured to temporarily reserve, as a work memory area, at least a part of a flash memory recording medium that is not the memory card,
is configured to manage the memory card and the work memory area as a single virtual device, using the virtual device file management information, and
is configured to abandon the virtual device file management information, and makes the work memory area available when the data aggregating process is completed using the memory card as the data destination, and the system is shutdown or the memory card is removed.

18. A data recording method for recording data on a first flash memory recording medium and a second flash memory recording medium, the data recording method comprising:
controlling, as a single virtual device, at least a part of he first flash memory recording medium and at least a part of the second flash memory recording medium; and
performing a programming process and an erasing process in parallel, the programming process for programming data on a memory area included in the virtual device and the first flash memory recording medium, and the erasing process for erasing the data from a memory area included in the virtual device and the second flash memory recording medium to generate a space area to be a programming destination in a subsequent programming process.
